(19) United States
(12) Patent Application Publication
(10) Pub. No.: US 2002/0113519 A1
(43) Pub. Date: Aug. 22, 2002

(54) Stator with molded insulator

(76) Inventor: Fred A. Brown, Coronado, CA (US)

Correspondence Address: Steven G. Saunders, Bromberg & Sunstein LLP, 125 Summer Street, Boston, MA, 02110-1618, US

(21) Appl. No.: 10/078,648

(22) Filed: Feb. 19, 2002

Related U.S. Application Data
(60) Provisional application No. 60/270,788, filed on Feb. 22, 2001.

(51) Int. Cl. H02K 1/12; H02K 1/04

(52) U.S. Cl. 310/254; 310/43

(57) ABSTRACT

A stator has an insulation layer that forms an insulating arbor. To that end, the stator includes a stator stack, and an insulator disposed upon at least a portion of the stator stack by an insert molding process. The insulator extends through the stator stack to form the noted arbor, which is adapted to receive a rotor.

This patent application claims priority from co-pending U.S. provisional patent application No. 60/270,788, filed Feb. 22,2001, and entitled, “STATOR WITH MOLDED INSULATOR,” the disclosure of which is incorporated herein, in its entirety, by reference.

### FIELD OF THE INVENTION

This invention relates generally to electric motors and, more particularly, this invention relates to devices and methods of insulating stators.

### BACKGROUND OF THE INVENTION

In simplified terms, electric motors (e.g., DC electric motors) typically have a rotating portion (“rotor”) and a stationary portion (“stator”). The rotor commonly has a magnet that interacts with a magnetic field (produced by the stator) that causes the rotor to rotate about an axis. Stated another way, the magnetic field produced by the stator causes the rotor to rotate about a shaft that is rotatably secured by the stator. To produce the magnetic field, the stator typically includes a metallic stator core, which is made up of a plurality of stacked metal laminations, a coil wrapped around the stator core, and a circuit board for selectively energizing the coil. Circuit elements on the circuit board detect the magnetic field produced by the rotor and thus, selectively energize the coil to provide rotating energy to the rotor.

The motor will be inoperable if there is an electrical connection between the coil and the stator core. Accordingly, motors typically have an insulation layer between the stator core and the coil to prevent such a connection. To that end, many motors include an insulation layer that is applied to the stator core by means of an electrostatic powder coating process. As known in the art, such a process requires many steps including, among others, using a specialized machine to apply a powder coating to the core, and then passing the coated stator core through a furnace. After it is passed through a furnace, the processed stator core still may not adequately insulate the coil from the stator core. In particular, the insulation layer may have small holes, referred to in the art as “pin holes.” Accordingly, more personnel are required to check each insulated stator core for pin holes, and then fill any located pin holes with some other insulating material.

A motor also typically includes an arbor for rotatably connecting the rotor to the stator. After it is fully assembled, a motor commonly is tested to ensure that it is properly balanced. If not properly balanced, the motor can malfunction and/or have a shorter life span. Motor imbalance may occur for a number of reasons. For example, the dimensions of the arbor, such as the arbor inner diameter, may vary from its intended dimension. In particular, arbors commonly are machined to specific dimensions. Due to inherent and known imperfections associated with machining processes, the actual dimensions of the arbor commonly are too variable to produce a properly balanced motor.

### SUMMARY OF THE INVENTION

In accordance with one aspect of the invention, a stator has an insulation layer that forms an insulating arbor. To that end, the stator includes a stator stack, and an insulator disposed upon at least a portion of the stator stack by an insert molding process. The insulator extends through the stator stack to form the noted arbor, which is adapted to receive a rotor.

In illustrative embodiments, the insulator comprises a hardened resin. The stator further may include a coil wrapped about the insulator, where the coil is electrically isolated from the stator stack. The insulator also may include at least one registration member. In some embodiments, the stator further includes a circuit board in registration with the insulator via the at least one registration member.

In accordance with another aspect of the invention, a method of producing a stator portion secures together a plurality of laminated sheets to form a core. It then continues to position the core into a molding apparatus, and control the molding apparatus to form an insulation layer about at least a portion of the core. The insulation layer includes an arbor through the core.

In illustrative embodiments, the molding apparatus is an insert molding apparatus. The method further may receive the core from the molding apparatus, and wind a coil about the core. The coil is electrically isolated from the laminated sheets by the insulation layer. Among other things, the insulation layer may be formed from a resin. The insulation layer further may include a registration member.

In accordance with other aspects of the invention, a DC motor includes a rotor having a shaft, and a stator. The stator includes a stator stack having an insulation layer that forms an integral arbor. The arbor extends through the stator stack, while the rotor shaft is within the arbor to secure the rotor and the stator.

The stator may include at least one coil about the insulation layer, where the insulation layer electrically isolates the stator stack from the coil. The insulation layer may be formed from a resin via insert molding processes, and/or may include at least one registration member. At least one bearing may be disposed within the arbor, where the bearing receives the rotor shaft.

### BRIEF DESCRIPTION OF THE DRAWINGS

The foregoing description of various embodiments of the invention should be appreciated more fully from the following further description thereof with reference to the accompanying drawings wherein:

FIG. 1 schematically shows an exploded view of a motor that incorporates illustrative embodiments of the invention.

FIG. 2A schematically shows a top view of an insulated stator core constructed in accordance with illustrative embodiments of the invention.

FIG. 2B schematically shows a bottom view of an insulated stator core constructed in accordance with illustrative embodiments of the invention.

FIG. 3 schematically shows a cross-sectional view of the insulated stator core shown in FIG. 2B as seen across line 3-3.

FIG. 4 schematically shows a cross-sectional view of an exemplary insert molding machine used to produce insulated stator cores.

FIG. 5 shows a process of producing a motor in accordance with illustrative embodiments of the invention.

### DESCRIPTION OF ILLUSTRATIVE EMBODIMENTS

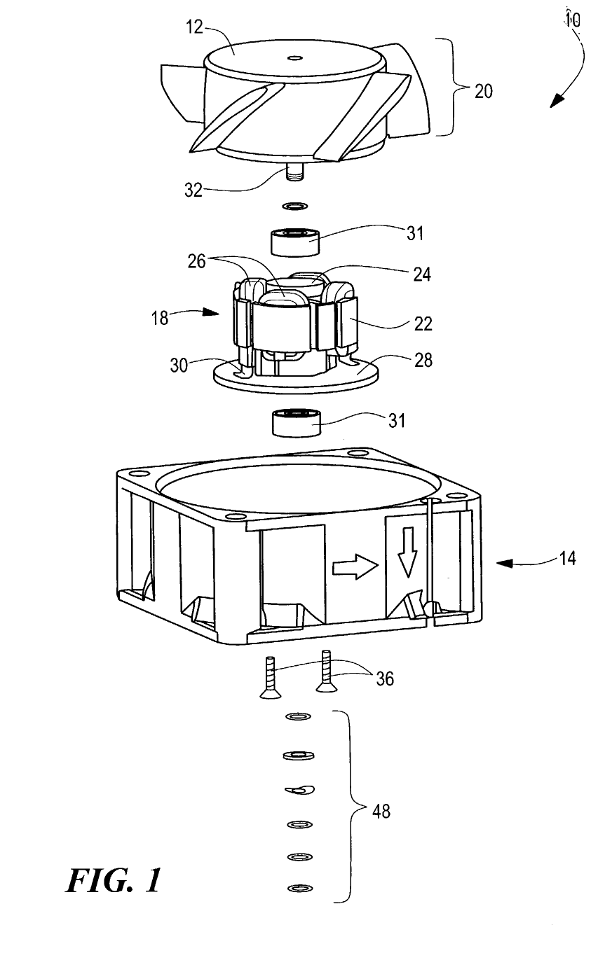

FIG. 1 schematically shows an exploded view of a motor (referred to herein as “motor 10”) that incorporates illustrative embodiments of the invention. The motor 10 has a stator core with an insert molded insulation layer. The insulation layer illustrative includes an integral arbor that also is manufactured by molding processes. Details of illustrative embodiments are discussed below.

The motor 10 shown in FIG. 1 includes a propeller 12 and thus, is a part of a cooling fan. To that end, the motor 10 includes a housing 14 with venturi (not shown), a stator portion 18 secured to the housing 14, and a rotor 20 (which includes the propeller 12). It should be noted that although the motor 10 is implemented as a fan, illustrative embodiments apply to other motor applications. Accordingly, description of the motor 10 as a fan is by illustration only and not intended to limit various embodiments of the invention.

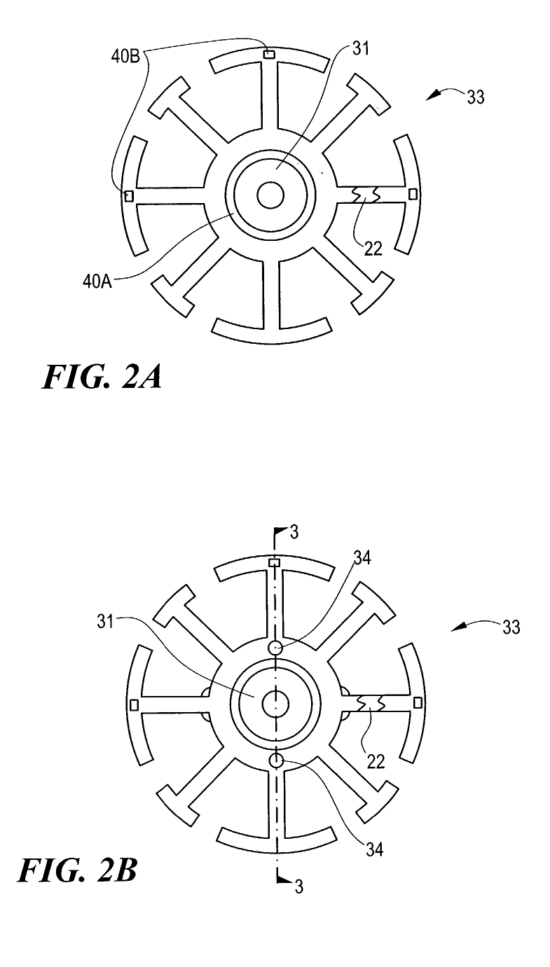

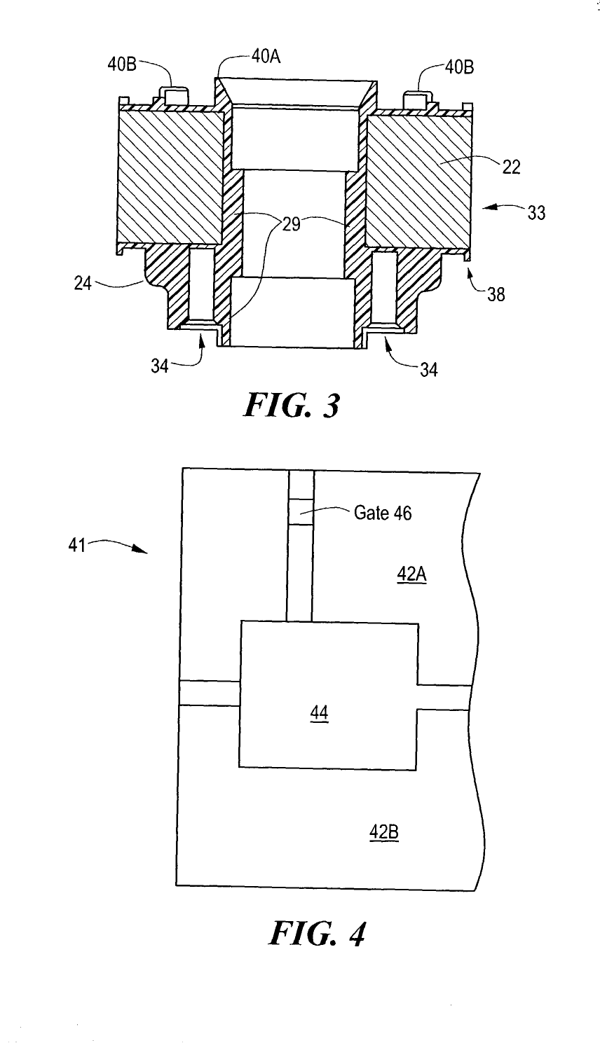

The stator 18 includes a stator core 22 (shown in greater detail in FIGS. 2A, 2B, and 3), a molded insulation layer 24 on the stator core 22, coils 26 wrapped about the stator core and the insulation layer 24, and a circuit board 28 having electronics for controlling the energization of the coils 26. As noted above, the insulation layer 24 includes an arbor 29 extending through a central tubular opening of the stator core 22. Bearings 31 are secured within the arbor 29 for receiving a rotor shaft (discussed below).

The circuit board 28 may be a printed circuit board having electronics for producing a magnetic field (via the coils 26) based upon the rotational position of the rotor 20. For example, for purposes of commutation, the circuit board 28 includes a magnetic sensor 30 (e.g., a Hall effect sensor), switching circuitry (not shown), and other related circuitry for controlling the flow of current to the coils 26. For additional details relating to circuit elements that may be included on the circuit board 28, see, for example, applicant's earlier U.S. Pat. No. 4,494,028, the disclosure of which is incorporated herein, in its entirety, by reference.

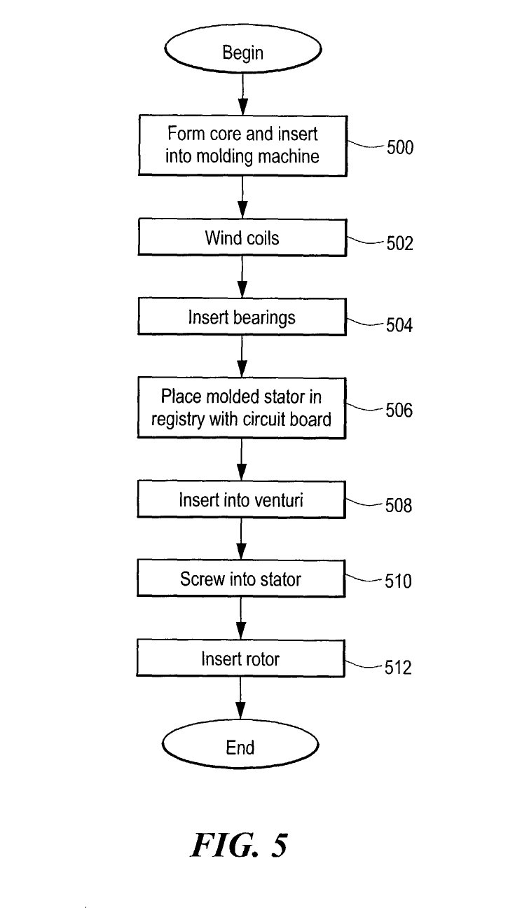

The rotor 20 includes a steel cup (not shown) for supporting the propeller 12, an annular permanent magnet circumscribing the interior of the steel cup, and a shaft 32 extending from the center of the steel cup. When assembled, the shaft 32 is received by the bearings 31 secured within the arbor 29. Details of one illustrative method of assembling the motor 10 are discussed below with reference to FIG. 5.

FIG. 2A schematically shows a top view of the stator core 22 after it is insulated, but before it is wrapped by the coil. The stator core 22 in this state is referred to herein as an “insulated stator core 33.” In a similar manner, FIG. 2B schematically shows a bottom view of the insulated stator core 33, and FIG. 3 shows a cross-sectional view of the insulated stator core 33 shown in FIG. 2B across line 3-3. As shown in these figures, the insulation layer 24 is disposed about the entire top surface and substantially all of the bottom surface of the stator core 22. In alternative embodiments, the insulation layer 24 is disposed about selected portions of the top and bottom surface. In yet other embodiments, the insulation layer is discontinuous.

Additionally, the insulation layer 24 includes the integral arbor 29 formed about the interior walls of the central tubular opening of the stator core 22. The arbor 29 extends from the top surface toward the bottom surface of the insulated stator core 33. As shown in FIG. 3, the arbor 29 illustratively extends beyond the bottom surface of the insulated stator core 33. In addition, the arbor 29 is molded to very specific tolerances to minimize balancing problems.

The insulated stator core 33 also includes a plurality of other elements that provide a number of useful functions. In particular, the insulation layer 24 includes two fastening holes 34 for receiving screws 36 (shown in FIG. 1) or other fasteners. As discussed with reference to FIG. 5, screws 36 secure the insulated stator core 33 to the circuit board 28 via these fastening holes 34. In addition, one or more registration members 38 may extend from one or both of the top and bottom surface of the insulated stator core 33. Such registration members 38 may be used to assemble the insulated stator core 33 in registry with other elements of the motor 10. As discussed below, registration members 38 mate with corresponding female portions (not shown) of the circuit board 28 to provide a registration fit.

In addition to the registration members 38, the insulation layer 24 also may include one or more coil retaining members. For example, the insulated stator core 33 shown in the figures includes an annular flange 40A, and teeth 40B extending from the top surface of the insulated stator core 33. These retaining members cooperate to ensure that the coils remain properly located on the stator 18.

FIG. 4 schematically shows a cross sectional view of a molding machine 41 that may be used in illustrative embodiments to produce the insulated stator core 33. In particular, the molding machine 41 may include two mold halves 42A and 42B that form a molding chamber 44, and one or more valve gates 46 that valve resin into the molding chamber 44. When in use, the stator core 22 is inserted into the molding chamber 44, and resin is injected through the valve gate(s) 46. Although only one valve gate 46 is shown, illustrative embodiments use more than one valve gate 46. For example, four valve gates 46 have provided satisfactory results. In illustrative embodiments, the resin may be FR530RYNITE™, available from E.I. du Pont Nemours and Company.

It should be noted that since FIG. 4 is a schematic drawing, the exact contours of the molds 42A and 42B (i.e., the shape of the molding chamber 44) are not shown in any detail. Accordingly, the shape of the molding chamber 44 may be any specific shape as required to implement illustrative embodiments of the invention. Moreover, the molding machine may be either a horizontal or vertical molding machine.

FIG. 5 shows a simplified process that may be used to produce a motor in accordance with illustrative embodiments of the invention. It should be noted that various steps of the process may be executed in a different order than that discussed. The order discussed thus is illustrative and not intended to limit the scope of the invention.

The process begins at step 500, in which the stator core 22 is formed and inserted into the molding machine 41 (shown in FIG. 4). Those skilled in the art understand that the stator core (a/k/a “stator stack”) is formed by securing together a plurality of metal laminations. Moreover, as noted above, the molding machine 41 preferably is one that uses insert molding techniques to produce the insulated stator core 33 with the integrated arbor 29, registration members 38, and coil retention members. In some embodiments, the arbor 29 is a separate molded part that is connected to the interior walls of the central tubular opening of the stator core 22. For example, the arbor 29 may be secured with some adhesive or connection member, or by a snap fit.

After the insulated stator core 33 is produced (i.e., with an integrated arbor 29, registration member and coil retaining members), the process continues to step 502, in which the coils 26 are wound onto specified parts of the insulated stator core 33. Winding the coil on the insulated stator core 33 produces poles that are generated when current is transmitted through the coils 26.

The process then continues to step 504, in which bearings 31 are inserted into and secured within the arbor 29. The insulated stator core 33 then is placed in registry with the circuit board 28 (step 506) and inserted into the housing 14 (step 508). To that end, the registration members 38 on the insulated stator core 33 are aligned with and inserted into corresponding female receiving portions of the circuit board 28. Screws 36 then are screwed into the insulation layer 24 (i.e., into the fastening holes 34) through the housing 14 and the circuit board 28 to secure the insulated stator core 33 and circuit board 28 within the housing 14 (step 510).

The process then continues to step 512, in which the rotor 20 is inserted through and secured by the bearings 31 in the arbor 29, thus completing the assembly process. Various washers and springs (collectively shown in FIG. 1 as reference number 48) are included about the shaft 32 and in the arbor 29 to secure the rotor 20 to the insulated stator core 33. The shaft 32 preferably has a longitudinal axis that is coincident with the center axis of the arbor 29 and insulated stator core 33.

Accordingly, the coils 26 are insulated from the stator core 22 by the insulation layer 24, which is insert molded. Insert molding the insulation layer 24 upon the stator core 22 significantly reduces the overhead and time required to produce the insulated stator core 33, thus saving manufacturing costs. In addition, including the arbor 29 with the insulation layer 24 significantly improves motor balancing since molding generally produces more consistently dimensioned arbors 29 than those produced by other conventionally known processes, such as by machining a metal arbor 29. Moreover, the registration members 38 and coil retaining members further ensure the integrity of the motor 10 by respectively properly aligning the insulated stator core 33 within the housing 14, and retaining the coil on the insulated stator core 33.

Although various exemplary embodiments of the invention have been disclosed, it should be apparent to those skilled in the art that various changes and modifications can be made that will achieve some of the advantages of the invention without departing from the true scope of the invention.

I claim:

1. A stator comprising:
a stator stack;
an insulator disposed upon at least a portion of the stator stack by an insert molding process,
the insulator extending through the stator stack to form an arbor, the arbor being adapted to receive a rotor.

2. The stator as defined by claim 1 wherein the insulator comprises a hardened resin.

3. The stator as defined by claim 1 further comprising a coil wrapped about the insulator, the coil being electrically isolated from the stator stack.

4. The stator as defined by claim 1 wherein the insulator includes at least one registration member.

5. The stator as defined by claim 4 further comprising a circuit board, the circuit board being in registration with the insulator via the at least one registration members.

6. A method of producing a stator portion, the method comprising:
securing together a plurality of laminated sheets to form a core;
positioning the core into a molding apparatus;
controlling the molding apparatus to form an insulation layer about at least a portion of the core, the insulation layer including an arbor through the core.

7. The product manufactured according to the process defined by claim 7.

8. The method as defined by claim 6 wherein the molding apparatus is an insert molding apparatus.

9. The method as defined by claim 6 further comprising:
receiving the core from the molding apparatus; and
winding a coil about the core, the coil being electrically isolated from the laminated sheets by the insulation layer.

10. The method as defined by claim 6 wherein the insulation layer is formed from a resin.

11. The method as defined by claim 6 wherein the insulation layer includes a registration member.

12. A DC motor comprising:
a rotor having a shaft; and
a stator, the stator including a stator stack having an insulation layer that forms an integral arbor, the arbor extending through the stator stack, the rotor shaft being within the arbor to secure the rotor and the stator.

13. The DC motor as defined by claim 12 wherein the stator includes at least one coil about the insulation layer, the insulation layer electrically isolating the stator stack from the coil.

14. The DC motor as defined by claim 12 wherein the insulation layer is formed from a resin via insert molding processes.

15. The DC motor as defined by claim 12 wherein the insulator includes at least one registration member.

16. The DC motor as defined by claim 12 further comprising at least one bearing within the arbor, the bearing receiving the rotor shaft.
